(19) United States
(12) Patent Application Publication
(10) Pub. No.: US 2002/0027185 A1
(43) Pub. Date: Mar. 7, 2002

(54) Suspension bracket for suspension fan

(75) Inventors: Kwing Wah Lee, Shatin (HK); Xue Qian Fu, Hue Bei Province (CN)

Correspondence Address: LEYDIG VOIT & MAYER, LTD, 700 THIRTEENTH ST. NW, SUITE 300, WASHINGTON, DC, 20005-3960, US

(73) Assignee: Using Co. Ltd., Kowloon (HK)

(21) Appl. No.: 09/920,949

(22) Filed: Aug. 3, 2001

(30) Foreign Application Priority Data
Aug. 25, 2000 (CN) 00238051.X

(51) Int. Cl. B42F 13/00

(52) U.S. Cl. 248/343

(57) ABSTRACT

A suspension bracket (10) for mounting a suspension fan having a fan motor (20) including a motor shaft (21) having an upper end provided with an enlarged support (22). The bracket (10) comprises a body (1) for fixing on a ceiling, and a mount (2) connected below the body (1) and formed with a substantially horizontal aperture (5) for engaging the support (22). The aperture (5) has a side opening (6) for accommodating the motor shaft (21) to allow the support (22) to be moved laterally to the aperture (5). The bracket (10 ) includes a fixing plate (3) for subsequently closing the side opening (6) of the aperture (5) to retain the support (22) in engagement by the aperture (5).

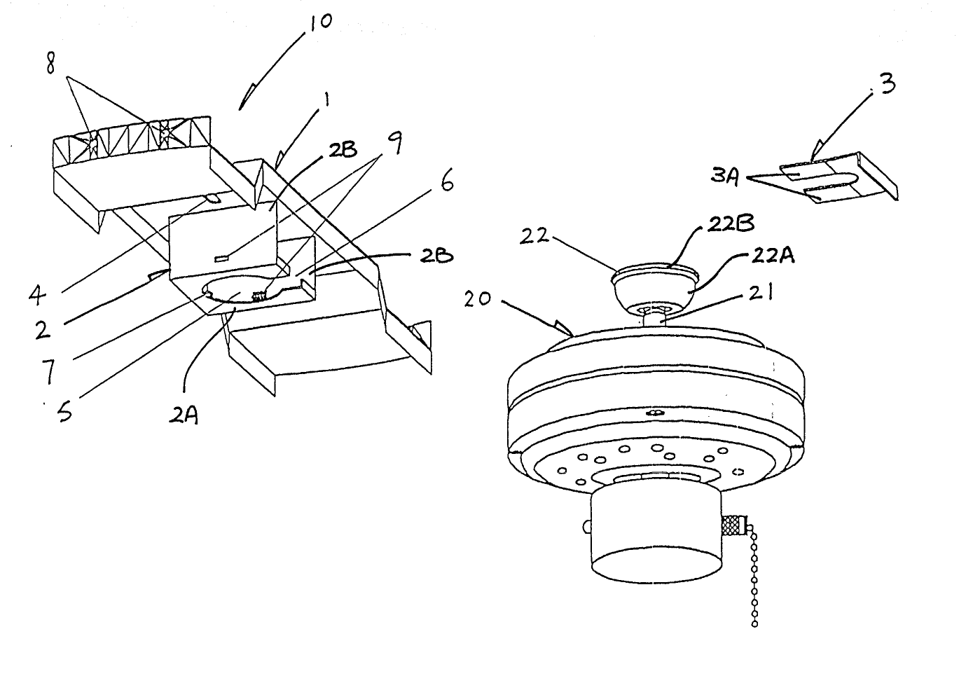

The present invention relates to a suspension bracket for mounting an electrical ceiling or suspension fan.

### BACKGROUND OF THE INVENTION

The pre-existing suspension fans are usually mounted to a ceiling by using a suspension bracket that is initially fixed to the ceiling and then by securing the head, i.e. the part at the upper end of the motor shaft of the fan, to the suspension bracket by means of a plate using screws. This method is found to be inconvenient for both mounting and dismounting a ceiling fan.

The invention seeks to mitigate or at least alleviate such a problem by proving an improved suspension bracket for a suspension fan.

### SUMMARY OF THE INVENTION

According to the invention, there is provided a suspension bracket for mounting a suspension fan having a fan motor including a motor shaft having an upper end provided with an enlarged support. The bracket comprises a body for fixing on a ceiling, and a mount connected below the body and formed with a substantially horizontal aperture for engaging said support. The aperture has a side opening for accommodating said motor shaft to allow said support to be moved laterally to the aperture. A fixing member subsequently closes the side opening of the aperture to retain said support in engagement by the aperture.

It is preferred that the aperture of the mount is of a size such that said support is engageable by the rim of and within the aperture.

Preferably, the mount is formed by a plate having a substantially horizontal bottom wall in which the aperture is formed and a pair of opposite side walls connected with the body.

More preferably, the fixing member is insertable into the mount for use, and the side walls of the mount are formed with respective inner protrusions close to the bottom wall to form a pair of opposed gaps with the bottom wall for locating the fixing member.

Further more preferably, the fixing member is in the form of a plate having a pair of bifurcate front ends.

In a preferred embodiment, the aperture is circular and its side opening is relatively narrower.

More preferably, the mount includes a key adjacent the aperture for engaging said support against rotation.

Advantageously, the body has opposite parts formed with holes to allow a hood of said fan to be secured to the body by means of screws to cover the entire bracket.

### BRIEF DESCRIPTION OF DRAWING

The invention will now be more particularly described, by way of example only, with reference to the accompanying drawing which is a perspective side and bottom view of an embodiment of a suspension bracket for a suspension fan in accordance with the invention.

### DESCRIPTION OF PREFERRED EMBODIMENT

Referring to the drawing, there is shown a suspension bracket 10 embodying the invention for mounting an electric motor 20 of a suspension fan to a ceiling. The bracket 10 comprises a horizontal oblong body 1 formed by a metal plate folded into a “ ” shape that generally resembles a flat letter “W” as shown, a central mount 2 formed by a rectangular U-shaped metal plate connected centrally to the lower side of the bracket body 1, and a separate metal fixing plate 3.

The fan motor 20 has a vertical shaft 21 and an enlarged suspension ball 22 supporting the shaft 21 by its upper end. The ball 22 has a generally hemispherical body 22A including a peripheral flange 22B around its upper equatorial plane. The suspension fan includes a cover or hood (not shown) for enclosing the entire bracket 10 as well as the ball 22 while the fan motor 20 is suspended, thereby resulting in a neat outlook appearance.

The bracket body 1 has a pair of holes 4 formed on opposite sides of the central mount 2 so that the body 1 can be secured to the ceiling by means of screws. Each of opposite ends of the bracket body 1 is folded upwards and formed with a pair of holes 8 to allow the aforesaid fan hood to be secured to the body 1 at opposite ends by means of screws.

The central mount 2 has a bottom wall 2A formed with a circular central aperture 5 which has a diameter slightly larger than the outer diameter of the body 22A (excluding the flange 22B) of the suspension ball 22. The aperture 5 is open on one side laterally of the bracket body 1 to form a relatively narrower opening 6 and is provided on the opposite side with an anti-rotation key 7. Opposite side walls 2B of the mount 2 are provided, on their inner surfaces and close to the bottom wall 2A, with respective protrusions 9 to form a pair of opposed gaps with the bottom wall 2A.

The fixing plate 3 is resiliently deformable and includes a pair of bifurcate front ends 3A. The plate 3 is intended to be inserted into the central mount 2 from the side thereof including the opening 6, at a position with its opposite side edges passing through the opposed gaps between the inner protrusions 9 and the bottom wall 2A.

In use, the suspension bracket 10 is fixed on the ceiling such that the central mount 2 is below the bracket body 1. The fan motor 20 is connected to the bracket 10 by placing the suspension ball 22 laterally into the central mount 2, with the shaft 21 entering into the aperture 5 of the mount 2 through the side opening 6. The opening 6 serves to accommodate the motor shaft 21 while the ball 22 is being moved into the mount 2.

The suspension ball 22 is then turned to align with the anti-rotation key 7 and then lowered into the aperture 5 until its peripheral flange 22B comes into contact with and rests on the rim of the aperture 5, for location through engagement thereby. Subsequently, the fixing plate 3 is inserted into the central mount 2 at a position as described above and immediately above the ball 22, thereby fixing the ball 22 within the aperture 5. The fixing plate 3 closes the side opening 6 of the aperture 5 and preferably bears resiliently against the upper surface of the ball 22 for a secure engagement. Finally, the aforesaid fan hood is installed to conceal the suspension bracket 10 by screws through the holes 8 of the bracket body 1.

In order to dismount the fan motor 20 from the suspension bracket 10, the fan hood is disassembled first and then the fixing piece 3 is pulled out from the central mount 2 to re-open aperture 5, whereupon the suspension ball 22 can be lifted up from the aperture 5 and then removed laterally from the mount 2.

As the suspension bracket 10 does not require the use of any screws to connect the suspension ball 22, mounting and dismounting of the fan motor 20 may be carried out conveniently and quickly. By reason of the ball 22 resting within the aperture 5 of the central mount 2 and being retained by the fixed plate 3, the connection is secure and safe.

The invention has been given by way of example only, and various modifications of and/or alterations to the described embodiment may be made by persons skilled in the art without departing from the scope of the invention as specified in the appended claims.

What is claimed is:

1. A suspension bracket for mounting a suspension fan having a fan motor including a motor shaft having an upper end provided with an enlarged support, which bracket comprises a body for fixing on a ceiling, a mount connected below the body and formed with a substantially horizontal aperture for engaging said support, said aperture having a side opening for accommodating said motor shaft to allow said support to be moved laterally to the aperture, and a fixing member for subsequently closing the side opening of the aperture to retain said support in engagement by the aperture.

2. The suspension bracket as claimed in claim 1, wherein the aperture of the mount is of a size such that said support is engageable by the rim of and within the aperture.

3. The suspension bracket as claimed in claim 1, wherein the mount is formed by a plate having a substantially horizontal bottom wall in which the aperture is formed and a pair of opposite side walls connected with the body.

4. The suspension bracket as claimed in claim 3, wherein the fixing member is insertable into the mount for use, and the side walls of the mount are formed with respective inner protrusions close to the bottom wall to form a pair of opposed gaps with the bottom wall for locating the fixing member.

5. The suspension bracket as claimed in claim 4, wherein the fixing member is in the form of a plate having a pair of bifurcate front ends.

6. The suspension bracket as claimed in claim 1, wherein the aperture is circular and its side opening is relatively narrower.

7. The suspension bracket as claimed in claim 6, wherein the mount includes a key adjacent the aperture for engaging said support against rotation.

8. The suspension bracket as claimed in claim 1, wherein the body has opposite parts formed with holes to allow a hood of said fan to be secured to the body by means of screws to cover the entire bracket.
